(19) United States
(12) Patent Application Publication
(10) Pub. No.: US 2010/0004783 A1
(43) Pub. Date: Jan. 7, 2010

(54) System For Collaboration Between Device and Person

(75) Inventors: Yoshito Ohtake, Saitama (JP); Hiroshi Miwa, Saitama (JP); Tetsuya Ozawa, Saitama (JP); Tatsuhiko Yamamoto, Saitama (JP); Kenichi Ohno, Saitama (JP); Shinichi Ikeda, Tokyo (JP); Kazuo Kojima, Tokyo (JP); Takayuki Ono, Tokyo (JP); Koji Yoneda, Mie (JP)

Correspondence Address: ARENT FOX LLP, 1050 CONNECTICUT AVENUE, N.W., SUITE 400, WASHINGTON, DC, 20036, US

(73) Assignee: HONDA MOTOR CO, LTD, TOKYO (JP)

(21) Appl. No.: 12/065,834

(22) PCT Filed: Sep. 5, 2005
(86) PCT No.: PCT/JP2005/016275

§ 371 Date: Aug. 25, 2009

(51) Int. Cl. G06F 19/00

(52) U.S. Cl. 700/245

(57) ABSTRACT

To make the most of characteristics of a device and a person and allow efficient handling even if a workpiece to be handled is changed when the device and the person perform operations in a shared area. The device 6 and the person 7 perform an assembling operation of a component to be assembled 3 to a vehicle body 2. When the assembling operation is classified into operations such as ejection of the component, conveyance, positioning, and mounting/fastening, a pattern 1 in which all the operations are performed by the device 6, and patterns 2 to 4 in which part of the operations are performed by only the person 7 or by the person and the device in collaboration and the remaining operations are performed by the device 6 are preset, and the patterns are switched according to the type of the component to be assembled 3 so as to make the most of high power of the device 6 and good judgment of the person 7 even if the type of the component to be assembled 3 is changed.

### TECHNICAL FIELD

The present invention relates to a technique for optimizing operation efficiency in collaboration between a device and a person.

### BACKGROUND ART

A line system has been known in which assembly is performed by collaboration between, for example, a movable robot suitable for conveying heavy objects and a person having good judgment in an assembly line of, for example, automobile components. For such a system, a known technique includes a step in which only the robot performs operations, a step in which only the person performs operations, and a step in which the robot and the person perform operations in collaboration, wherein the robot and the person perform operations in collaboration, for example, when the robot receives unmachined workpieces or delivers machined workpieces, and an output of a motor or the like of the robot at this time is limited to a low level for safety, while only the robot performs operations in machining workpieces in a machining facility within a safety fence, and the limit on the output is removed in this case (for example, see Patent Document 1).

### Patent Document 1: Japanese Patent Application Publication No. 2001-341086

### DISCLOSURE OF THE INVENTION

In the above described technique, an area where only the robot performs operations, an area where only the person performs operations, and an area where the robot and the person perform operations in collaboration are predetermined, the operations are performed in the predetermined areas by predetermined procedures. In recent automobile assembly lines or the like, small-lot production of various products has been increasing rather than mass production. In such a case, workpieces of various shapes, weights, and materials are handled, and thus a system in which a robot and a person perform operations by predetermined procedures sometimes cannot accommodate the various workpieces, which may increase wasted time or burden on the person.

Therefore, the present invention has an object to provide an operation system that can efficiently handle a workpiece according to the type thereof when a device and a person perform operations in a shared area.

In order to achieve the above described object, the present invention provides an operation system in which a device and a person perform various operations in a shared area, wherein a pattern in which all the operations are performed by the device, and a pattern in which at least part of the operations are performed by the person and the remaining operations are performed by the device are switchable.

When the operations include, for example, ejection of a component to be assembled, conveyance, positioning, and assembling/fastening, the operations are classified into a plurality of patterns such as a pattern in which all the operations are performed by the device, a pattern in which the ejection of the component to be assembled is performed by only the person or by the person and the device in collaboration and the other operations are performed by the device, and a pattern in which the ejection of the component to be assembled and the positioning are performed by only the person or by the person and the device in collaboration and the other operations are performed by the device, and the patterns are switchable as appropriate. This allows proper accommodation according to a component to be handled, and allows efficient handling making the most of good judgment of the person and high power of the device.

When a device and a person perform operations in a shared area, various patterns for shares of operations are preset, and the patterns are switched to allow proper sharing of the operations according to the type of a workpiece, and allow efficient handling making the most of characteristics of the person and the device.

Also, operation modes such as a mode in which operations in one cycle are performed by only an automatically operating device, a mode in which some steps in the cycle is performed by a person (the other steps are performed by the automatically operating device), and a mode in which the device is assist-controlled in some steps, and the steps are performed while the person providing vectors to the device (the other steps are performed by the automatically operating device) are switched for efficient handling so as to accommodate changes in operation conditions due to various reasons.

### BRIEF DESCRIPTION OF THE DRAWINGS

FIG. 1 illustrates an example of a shared area for operations by a device and a person, seen from above; and

FIG. 2 illustrates an example of patterns for shares of operations.

### BEST MODE FOR CARRYING OUT THE INVENTION

An embodiment of the present invention will be described with reference to the accompanying drawings.

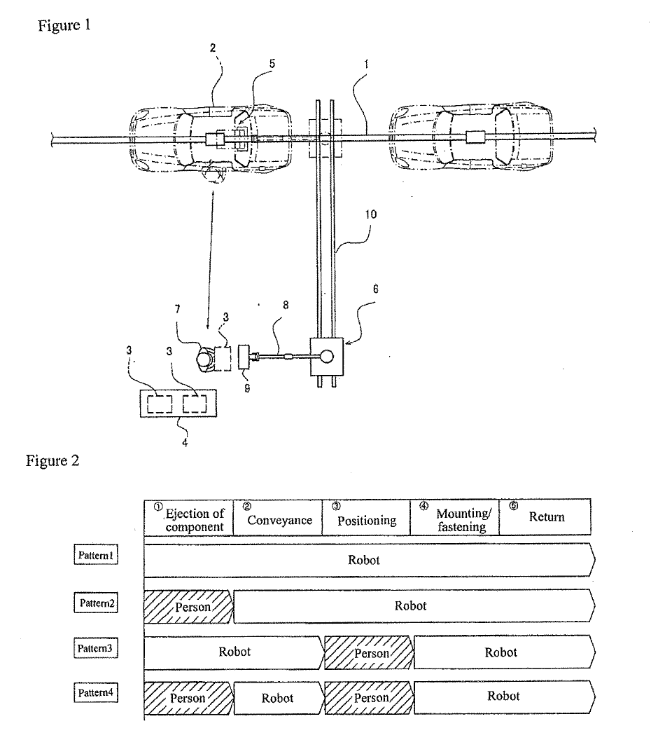

FIG. 1 illustrates an example of a shared area for operation by a device and a person, seen from above, and FIG. 2 illustrates an example of patterns for shares of operations.

A system for collaboration between a device and a person according to the present invention is adapted to efficiently handle a workpiece according to the type thereof when a device and a person perform operations in a shared area, for example, in an automobile assembly line, previously classify shares of operations by the device and the person into a plurality of patterns according to the type of the workpiece, and switch the patterns for optimum operation efficiency.

The system for collaboration between a device and a person according to the embodiment is applied to, for example, an automobile assembly line as shown in FIG. 1. In this operation area, a component to be assembled 3 is assembled around the underbody of a vehicle body 2 conveyed by an overhead conveyor 1, the component to be assembled 3 in a component supply position 4 is conveyed to a component mounting position 5 below the overhead conveyor 1, and then the component to be assembled 3 is positioned in a predetermined position below the vehicle body 2 and assembled to the vehicle body 2.

A device 6 includes a workpiece grip portion 9 at a tip of an arm 8, and is movable along a runway 10.

Such an assembling operation can be classified into operations such as ejection of the component to be assembled 3 in the component supply position 4, conveyance to the component mounting position 5, positioning in the predetermined position, assembling/fastening, and return to an original position.

Thus, in the present invention, as shown in FIG. 2, the operations are classified into, for example, a pattern 1 in which all the operations are performed by the device 6, a pattern 2 in which only the ejection of the component to be assembled 3 is performed by only the person 7 or by the person and the device in collaboration and all the remaining operations are performed by the device 6, a pattern 3 in which only the positioning is performed only by the person 7 or by the person and the device in collaboration and all the remaining operations are performed by the device 6, and a pattern 4 in which the ejection of the component to be assembled 3 and the positioning are performed only by the person 7 or by the person and the device in collaboration and the remaining operations are performed by the device 6, and the patterns are switched as appropriate according to the type of the component to be assembled 3 so as to make the most of characteristic of the device 6 having high power and free of fatigue and the person 7 having good judgment.

Specifically, the pattern I is selected when a component to be assembled 3 is handled such that ejection of the component to be assembled 3, conveyance, positioning, mounting/fastening, and return can be performed only by the device 6. The pattern 2 is selected when, for example, the ejection of the component to be assembled 3 cannot be easily performed by the device 6 but the component to be assembled 3 can be easily gripped with the aid of the person 7. The pattern 3 is selected when positioning and mounting/fastening cannot be easily performed by the device 6 but can be easily performed with the aid of the person 7. The pattern 4 is selected when the cases of the patterns 2 and 4 overlap.

As a specific method of pattern switching, for example, the person 7 switches a control switch or the like of the device 6 according to the type of the component to be assembled 3.

The example in FIG. 1 shows a specific example of the pattern 3 in which the component to be assembled 3 in the component supply position 4 is taken out and transferred to the workpiece grip portion 9 of the device 6 by only the person 7 or by the person and the device in collaboration, the device 6 having received the component to be assembled 3 runs along the runway 10 to convey the component to be assembled 3 to the component mounting position 5, then the component to be assembled 3 is positioned in a predetermined position by only the person 7 or by the person and the device in collaboration, and the device 6 performs mounting/fastening. The patterns can be switched according to the type of the component to be assembled 3 to properly switch shares of operations by the device 6 and the person 7, thereby providing an operation system making the most of characteristics of the person and the device.

Next, a specific example will be described of switching between an operation mode in which all steps are automatically performed by a device and an operation mode in which some steps are performed by a person (the other steps are performed by the automatically operating device).

In an operation including a step of transferring a component (assembly) from a supply position to a grip portion of the device, all the steps are performed by the automatically operating device if the device can easily grip the component (assembly) at the grip portion. This includes the case where other components are not mounted to a position in the component (assembly) that may be interfered by the grip portion, or the case where no object that may be interfered is provided in an operation area of the grip portion and teaching of an automatic operation of the device can be easily performed.

If the device cannot easily grip the component (assembly) at the grip portion, the component (assembly) is transferred from the supply position to the grip portion of the device by a person. This includes the case where other components are mounted to a position in the component (assembly) that may be interfered in an operation area of the grip portion, particularly, where a harness, a band, a spring, or the like is not secured, or the case where an object that may be interfered is provided in the operation area of the grip portion and teaching of an automatic operation of the device cannot be easily performed.

Another example will be described of switching between an operation mode in which all steps are automatically performed by a device except target marker setting (performed by a person) and an operation mode in which a tank is mounted to a vehicle body by an assist mode (the other steps are performed by the automatically operating device).

If the device can easily position the tank on the vehicle body in place, positioning is performed by the automatically operating device, target marker setting is performed by a person, and fastening is automatically performed.

If the device cannot easily position the tank on the vehicle body in place, the tank is automatically moved to a position close to a tank mounting position on the vehicle body by the device, and positioning and mounting are performed by an assist mode. For example, if teaching cannot be easily performed because of the influence of the shape of the vehicle body in the tank mounting position or other components (such as a harness or a hose) that may cause interference, target marker setting is performed by a person, and fastening is automatically performed.

In the above described embodiment, the assembling operation of the vehicle body is taken as an example of operations, but the present invention may be, of course, applied to operations other than the assembling operation. The device 6 is not limited to the conveying device.

### INDUSTRIAL APPLICABILITY

Patterns for shares of operations by a device and a person are switched to allow operations making the most of characteristics of the device and the person, and facilitate efficient operations.

1. A system for collaboration between a device and a person in which a device and a person perform various operations in a shared area,
wherein a pattern in which all the operations are performed by the device, and a pattern in which at least part of the operations are performed by only the person or by the person and the device in collaboration and the remaining operations are performed by the device are switchable.
